(19) United States
(12) Patent Application Publication
(10) Pub. No.: US 2026/0128704 A1
(43) Pub. Date: May 7, 2026

(54) TOPOLOGICAL CIRCUIT AND CONTROL STRATEGY FOR DRIVING SWITCHED RELUCTANCE MOTOR (SRM)

(71) Applicant: Taiyuan University of Technology, Taiyuan City (CN)

(72) Inventor: Haitao Sun, Taiyuan City (CN)

(21) Appl. No.: 19/374,816

(22) Filed: Oct. 30, 2025

(30) Foreign Application Priority Data
Nov. 1, 2024 (CN) 202411550408.6
Jul. 3, 2025 (CN) 202510915721.3

(51) Int. Cl. H02P 27/06; H02P 9/30; H02P 21/00; H02P 21/22

(52) U.S. Cl. CPC H02P 27/06; H02P 9/30; H02P 21/0021; H02P 21/22; H02P 2209/07; H02P 2209/11

(57) ABSTRACT

Provided are a topological circuit and a control strategy for driving a switched reluctance motor (SRM). In one aspect, an SRM has an N-phase winding structure, N=M×K; the symmetrical K-phase windings in each set of symmetrical K-phase windings are connected in a star configuration; midpoints of M power switch bridge arms are connected to neutral points of M sets of symmetrical K-phase windings in one-to-one correspondence; and K output terminals of M K-phase inverters are connected to lead-out terminals of the M sets of symmetrical K-phase windings in one-to-one correspondence. In another aspect, an SRM has N phases of windings connected in a star configuration; a midpoint of an additional bridge arm is connected to a neutral point for the N phases of windings; midpoints of N inverter bridge arms are connected to lead-out terminals of the N phases of windings in one-to-one correspondence.

### CROSS REFERENCE TO RELATED APPLICATION

The present application claims priority to the Chinese Patent Application No. 202411550408.6, filed with the China National Intellectual Property Administration on Nov. 1, 2024, and entitled “TAIL-TYPE TOPOLOGICAL CIRCUIT AND CONTROL STRATEGY FOR DRIVING SWITCHED RELUCTANCE MOTOR (SRM)”, and the Chinese Patent Application No. 202510915721.3, filed with the China National Intellectual Property Administration on Jul. 3, 2025, and entitled “SHORT-TAIL TOPOLOGICAL CIRCUIT AND CONTROL STRATEGY FOR DRIVING SWITCHED RELUCTANCE MOTOR (SRM)”, which are incorporated herein by reference in their entirety.

### TECHNICAL FIELD

The present disclosure relates to the technical field of driving control on switched reluctance motors (SRMs), and in particular to a topological circuit and control strategy for driving an SRM.

### BACKGROUND

Switched reluctance motors (SRMs), as typical rare-earth-free motors, avoid the use of rare-earth permanent magnetic materials in the manufacturing process, reducing the manufacturing cost, and eliminating the demagnetization risk of the permanent magnetic materials in extreme operating conditions. Compared with such rare-earth-free motors as induction motors and synchronous reluctance motors, the SRMs feature a simple rotor structure, high strength, and low cost, making them more suitable for high temperatures, high pressures, vacuum environments, low temperatures, high-frequency vibration, and other extreme operating conditions.

The conventional asymmetrical half-bridge power converter circuit and the modular converter circuit are two main types of driving control circuits for the SRMs at present. For the conventional asymmetrical half-bridge power converter circuit, asymmetrical half-bridge circuits are respectively connected to two terminals of each winding. The asymmetrical half-bridge circuits are used to perform unipolar excitation on the winding, thereby generating a unidirectional pulsed winding current. For the modular converter circuit, an additional bridge arm composed of two power switches is connected to a neutral point for three-phase windings. The additional bridge arm and the inverter bridge arm connected to the other terminal of each winding jointly constitute an H-bridge circuit. The H-bridge circuit is used to perform bipolar excitation on each winding, thereby generating a bidirectional pulsed winding current.

However, the above two types of driving control circuits suffer from the following problems in actual application: Severe fluctuations will occur during commutation, resulting in large torque ripples of the SRMs. On the other hand, all control strategies lack control over axial and radial torque components, causing large noise of the SRMs in axial and radial directions. Due to the above problems, the SRMs exhibit poor operation performance.

### SUMMARY

An objective of the present disclosure is to provide a topological circuit and control strategy for driving an SRM. The present disclosure can effectively reduce torque ripples and noise generated by the SRM, and improve the operating performance of the SRM.

To achieve the above objective, the present disclosure provides the following technical solutions:

According to a first aspect, the present disclosure provides a topological circuit for driving an SRM. The topological circuit for driving an SRM includes an SRM, a capacitor (C), M power switch bridge arms, and M K-phase inverters, M and K each being a positive integer, and K≥2, where
the SRM has an N-phase winding structure, N=M×K; every K phases of windings form an independent set of symmetrical K-phase windings; and the symmetrical K-phase windings in each set of symmetrical K-phase windings are connected in a star configuration;
two terminals of the capacitor (C) are respectively connected to a positive power terminal and a negative power terminal;
positive input terminals of the M power switch bridge arms are connected to the positive power terminal; negative input terminals of the M power switch bridge arms are connected to the negative power terminal; and midpoints of the M power switch bridge arms are connected to neutral points of M sets of symmetrical K-phase windings in one-to-one correspondence; and
positive input terminals of the M K-phase inverters are connected to the positive power terminal; negative input terminals of the M K-phase inverters are connected to the negative power terminal; and K output terminals of the M K-phase inverters are connected to lead-out terminals of the M sets of symmetrical K-phase windings in one-to-one correspondence.

According to a second aspect, the present disclosure further provides a control strategy for driving an SRM. The control strategy for driving an SRM is realized based on the topological circuit for driving an SRM in the first aspect, and the control strategy for driving an SRM includes following control modes:

### I: A Motor Mode:

controlling the M K-phase inverters with a universal method, such that a direct-current (DC) power supply is converted into M K-phase alternating-current (AC) power supplies by the M K-phase inverters, and the M sets of symmetrical K-phase windings are powered on; and
controlling the M power switch bridge arms, such that actual values of currents at the neutral points of the M sets of symmetrical K-phase windings each are maintained at a preset reference value, and an actual value of a current of each phase of winding is greater than or equal to 0 A, or the actual value of the current of each phase of winding is less than or equal to 0 A, thereby keeping the current of each phase of winding at a same direction, and enabling the SRM to enter the motor mode; and

### II: A Generator Mode:

controlling the M power switch bridge arms, such that a power switch in each of the M power switch bridge arms is conducted; and controlling the M K-phase inverters, such that a power switch in each of the M K-phase inverters is conducted, where starting from the positive power terminal, an exciting current sequentially flows through the power switch conducted in the power switch bridge arm, one phase of winding in the symmetrical K-phase windings and the power switch conducted in the K-phase inverter to the negative power terminal, or sequentially flows through the power switch conducted in the K-phase inverter, the winding in the symmetrical K-phase windings and the power switch conducted in the power switch bridge arm to the negative power terminal, thereby enabling the SRM to enter an excitation state; and
upon completion of excitation, enabling the SRM to rotate continuously, and turning off the M power switch bridge arms, such that the SRM enters a generating mode.

According to a third aspect, the present disclosure provides a topological circuit for driving an SRM. The topological circuit for driving an SRM includes an SRM, an additional bridge arm, and N inverter bridge arms, N being a positive integer, and N≥2, where
the SRM has N phases of windings connected in a star configuration;
the additional bridge arm includes a freewheeling diode (FWD) and a power switch that are connected in series;
a positive input terminal of the additional bridge arm is connected to a positive power terminal; a negative input terminal of the additional bridge arm is connected to a negative power terminal; and a midpoint of the additional bridge arm is connected to a neutral point for the N phases of windings; and
positive input terminals of the N inverter bridge arms are connected to the positive power terminal; negative input terminals of the N inverter bridge arms are connected to the negative power terminal; midpoints of the N inverter bridge arms are connected to lead-out terminals of the N phases of windings in one-to-one correspondence; and the N inverter bridge arms jointly constitute an N-phase inverter.

According to specific embodiments provided in the present disclosure, the present disclosure discloses the following technical effects:

The two topological circuits in the present disclosure do not compromise the structure of the SRM. The constructed brand-new (tail-type) topological circuit and the control strategy fully ensure symmetry for the windings of the motor in the driving control process. Meanwhile, the currents of the windings can change continuously as needed, such that the currents of the windings are commutated smoothly, thereby reducing torque ripples of the motor. Furthermore, the present disclosure can further control axial and radial torque components, thereby effectively reducing the noise of the motor in axial and radial directions, effectively reducing the torque ripples and noise of the SRM, and effectively improving the operating performance of the SRM.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic diagram of a topological circuit for driving an SRM according to an embodiment of the present disclosure;

FIG. 2 is a schematic diagram of a first flow direction of an exciting current in a control strategy for driving an SRM according to an embodiment of the present disclosure;

FIG. 3 is a schematic diagram of a second flow direction of an exciting current in a control strategy for driving an SRM according to an embodiment of the present disclosure;

FIG. 4 is a first schematic diagram of a topological circuit for driving an SRM according to another embodiment of the present disclosure;

FIG. 5 is a second schematic diagram of a topological circuit for driving an SRM according to another embodiment of the present disclosure;

FIG. 6 is a schematic diagram of an excitation path in a three-phase conduction mode of a first control strategy according to another embodiment of the present disclosure;

FIG. 7 is a schematic diagram of a freewheeling path in a three-phase conduction mode of a first control strategy according to another embodiment of the present disclosure;

FIG. 8 is a schematic diagram of an excitation path in a two-phase conduction mode of a first control strategy according to another embodiment of the present disclosure;

FIG. 9 is a schematic diagram of a freewheeling path in a two-phase conduction mode of a first control strategy according to another embodiment of the present disclosure;

FIG. 10 is a schematic diagram of a first demagnetization path in a two-phase conduction mode of a first control strategy according to another embodiment of the present disclosure;

FIG. 11 is a schematic diagram of a second demagnetization path in a two-phase conduction mode of a first control strategy according to another embodiment of the present disclosure;

FIG. 12 is a schematic diagram of an excitation path in a single-phase conduction mode of a first control strategy according to another embodiment of the present disclosure;

FIG. 13 is a schematic diagram of a freewheeling path in a single-phase conduction mode of a first control strategy according to another embodiment of the present disclosure;

FIG. 14 is a schematic diagram of an excitation path in a three-phase conduction mode of a second control strategy according to another embodiment of the present disclosure;

FIG. 15 is a schematic diagram of a freewheeling path in a three-phase conduction mode of a second control strategy according to another embodiment of the present disclosure;

FIG. 16 is a schematic diagram of an excitation path in a two-phase conduction mode of a second control strategy according to another embodiment of the present disclosure;

FIG. 17 is a schematic diagram of a freewheeling path in a two-phase conduction mode of a second control strategy according to another embodiment of the present disclosure;

FIG. 18 is a schematic diagram of a first demagnetization path in a two-phase conduction mode of a second control strategy according to another embodiment of the present disclosure;

FIG. 19 is a schematic diagram of a second demagnetization path in a two-phase conduction mode of a second control strategy according to another embodiment of the present disclosure;

FIG. 20 is a schematic diagram of an excitation path in a single-phase conduction mode of a second control strategy according to another embodiment of the present disclosure;

FIG. 21 is a schematic diagram of a freewheeling path in a single-phase conduction mode of a second control strategy according to another embodiment of the present disclosure; and

FIG. 22 is a schematic diagram of a technical evolution path of a topological circuit for driving an SRM according to the present disclosure.

In the figures, a dotted arrow represents a direction for actual currents of windings.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a topological circuit and control strategy for driving an SRM. The present disclosure can effectively reduce torque ripples and noise generated by the SRM, and improve the operating performance of the SRM.

To make the above objectives, features, and advantages of the present disclosure more obvious and easy to understand, the present disclosure will be further described in detail with reference to the accompanying drawings and specific implementations.

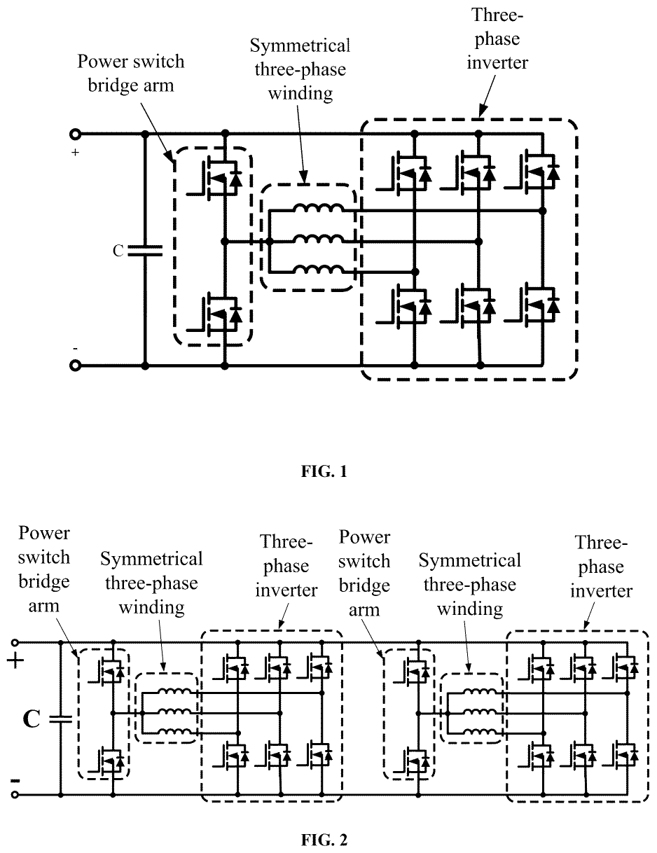

In an exemplary embodiment, as shown in FIG. 1, the topological circuit for driving an SRM includes an SRM, a capacitor C, M power switch bridge arms, and M K-phase inverters, M and K each being a positive integer, and K≥2.

The SRM has an N-phase winding structure, N=M×K. Every K phases of windings form an independent set of symmetrical K-phase windings. The symmetrical K-phase windings in each set of symmetrical K-phase windings are connected in a star configuration. Two terminals of the capacitor C are respectively connected to a positive power terminal and a negative power terminal. Positive input terminals of the M power switch bridge arms are connected to the positive power terminal. Negative input terminals of the M power switch bridge arms are connected to the negative power terminal. Midpoints of the M power switch bridge arms are connected to neutral points of M sets of symmetrical K-phase windings in one-to-one correspondence. Positive input terminals of the M K-phase inverters are connected to the positive power terminal. Negative input terminals of the M K-phase inverters are connected to the negative power terminal. K output terminals of the M K-phase inverters are connected to lead-out terminals of the M sets of symmetrical K-phase windings in one-to-one correspondence.

As shown in FIG. 2 and FIG. 3, the embodiment further provides a control strategy for driving an SRM. The control strategy for driving an SRM is realized based on the above topological circuit for driving an SRM. The control strategy includes following control modes:

### I: A Motor Mode:

The M K-phase inverters are controlled with a universal method, such that a DC power supply is converted into M K-phase AC power supplies by the M K-phase inverters, and the M sets of symmetrical K-phase windings are powered on.

The M power switch bridge arms are controlled, such that actual values of currents at the neutral points of the M sets of symmetrical K-phase windings are maintained at a preset reference value, and an actual value of a current of each phase of winding is greater than or equal to 0 A, or the actual value of the current of each phase of winding is less than or equal to 0 A, thereby keeping the current of each phase of winding at a same direction, and enabling the SRM to enter the motor mode.

### II: A Generator Mode:

The M power switch bridge arms are controlled, such that a power switch in each of the M power switch bridge arms is conducted. The M K-phase inverters are controlled, such that a power switch in each of the M K-phase inverters is conducted. Starting from the positive power terminal, an exciting current sequentially flows through the power switch conducted in the power switch bridge arm, one phase of winding in the symmetrical K-phase windings and the power switch conducted in the K-phase inverter to the negative power terminal, or sequentially flows through the power switch conducted in the K-phase inverter, the winding in the symmetrical K-phase windings and the power switch conducted in the power switch bridge arm to the negative power terminal, thereby enabling the SRM to enter an excitation state.

Upon completion of excitation, the SRM rotates continuously, and the M power switch bridge arms are turned off, such that the SRM enters a generating mode.

The universal method includes, but is not limited to, a trapezoidal current driving method, a sinusoidal current control method, a field-oriented control method, a space vector control method, or a field weakening control method.

There are three methods for setting the reference value for the current at the neutral point:

A first method is to directly set the reference value.

A second method is to sum peaks of currents of K bridge arms of the K-phase inverter, and set a summed result as the reference value for the current at the neutral point. Taking a three-phase inverter as an example, a set formula is as follows:

$${i}_{tail}^{*} = {\vert {i}_{l e g 1} \vert}_{p e a k} + \vert {i}_{l e g 2} {\vert}_{p e a k} + \vert {i}_{l e g 3} {\vert}_{p e a k}$$

where

$${i}_{tail}^{*}$$

represents a reference value for a current at a neutral point, |i_{leg1}|ₚₑₐₖ represents a peak of a current of a first bridge arm of the three-phase inverter, |i_{leg2}|ₚₑₐₖ represents a peak of a current of a second bridge arm of the three-phase inverter, and |i_{leg3}|ₚₑₐₖ represents a peak of a current of a third bridge arm of the three-phase inverter.

A third method is to sum absolute values of reference values of amplitudes of the currents of the K bridge arms of the K-phase inverter, multiply a summed result by 1.5, and set a resulting product as the reference value for the current at the neutral point. Taking the three-phase inverter as an example, a set formula is as follows:

$${i}_{tail}^{*} = 1 \text{.5} ( \vert {i}_{a}^{*} \vert + \vert {i}_{b}^{*} \vert + \vert {i}_{c}^{*} \vert )$$

where

$${i}_{tail}^{*}$$

represents the reference value for the current at the neutral point,

$${i}_{a}^{*}$$

represents a reference value of an amplitude of the current of the first bridge arm of the three-phase inverter,

$${i}_{b}^{*}$$

represents a reference value of an amplitude of the current of the second bridge arm of the three-phase inverter, and

$${i}_{c}^{*}$$

represents a reference value of an amplitude of the current of the third bridge arm of the three-phase inverter.

In the generator mode, by controlling the M K-phase inverters, generation performance parameters of the SRM can be controlled. The generation performance parameters include a generating voltage, a generating current, and a generating power.

In another exemplary embodiment, the topological circuit for driving an SRM includes an SRM, an additional bridge arm, and N inverter bridge arms, N being a positive integer, and N≥2.

The SRM has N phases of windings connected in a star configuration. The additional bridge arm includes an FWD and a power switch that are connected in series. A positive input terminal of the additional bridge arm is connected to a positive power terminal. A negative input terminal of the additional bridge arm is connected to a negative power terminal. A midpoint of the additional bridge arm is connected to a neutral point for the N phases of windings. Positive input terminals of the N inverter bridge arms are connected to the positive power terminal. Negative input terminals of the N inverter bridge arms are connected to the negative power terminal. Midpoints of the N inverter bridge arms are connected to lead-out terminals of the N phases of windings in one-to-one correspondence. The N inverter bridge arms jointly constitute an N-phase inverter.

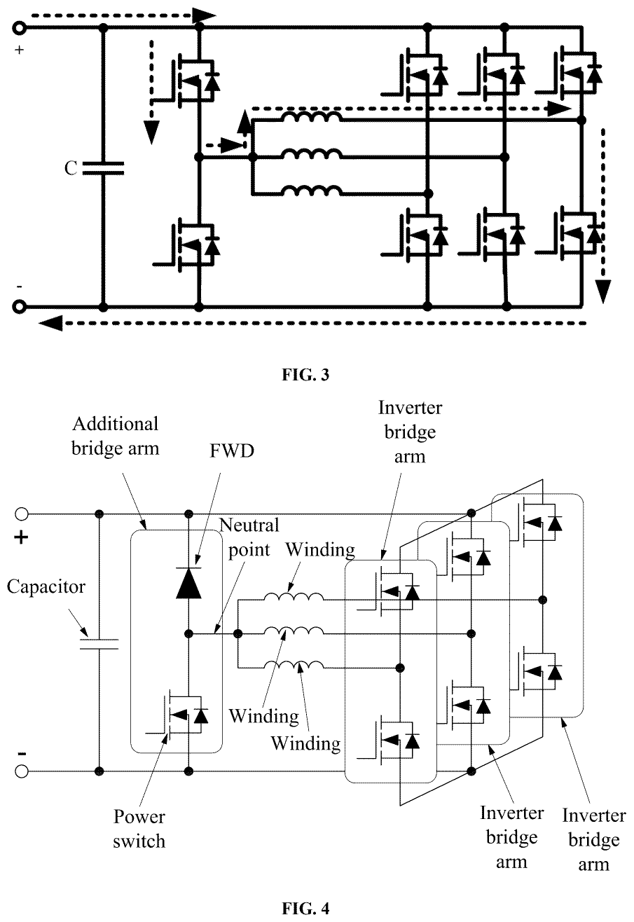

In the embodiment, a cathode of the FWD of the additional bridge arm serves as the positive input terminal of the additional bridge arm. An anode of the FWD of the additional bridge arm is connected to a drain of the power switch of the additional bridge arm. A source of the power switch of the additional bridge arm serves as the negative input terminal of the additional bridge arm. See FIG. 4 for specific details.

If N=3, a control strategy based on the topological circuit includes:

### I: A Three-Phase Conduction Mode:

The power switch of the additional bridge arm is conducted to three-phase windings, such that the SRM enters the three-phase conduction mode. In this mode, a three-phase inverter is controlled with a universal method, such that upper power switches of three inverter bridge arms are conducted alternately, and when an upper power switch of one inverter bridge arm is conducted, lower power switches of the other two inverter bridge arms are conducted, or lower power switches of the three inverter bridge arms are conducted alternately, and when a lower power switch of one inverter bridge arm is conducted, upper power switches of the other two inverter bridge arms are conducted.

Taking that an upper power switch of an inverter bridge arm A, a lower power switch of an inverter bridge arm B, and a lower power switch of an inverter bridge arm C are conducted at the same time as an example, an excitation path and a freewheeling path are respectively as follows:

In the excitation path, starting from the positive power terminal, an exciting current sequentially flows through the upper power switch of the inverter bridge arm A and a phase-A winding to a neutral point for the three-phase windings, then flows through the power switch of the additional bridge arm to the negative power terminal in a first path, sequentially flows through a phase-B winding and the lower power switch of the inverter bridge arm B to the negative power terminal in a second path, and sequentially flows through a phase-C winding and the lower power switch of the inverter bridge arm C to the negative power terminal in a third path. See FIG. 6 for specific details.

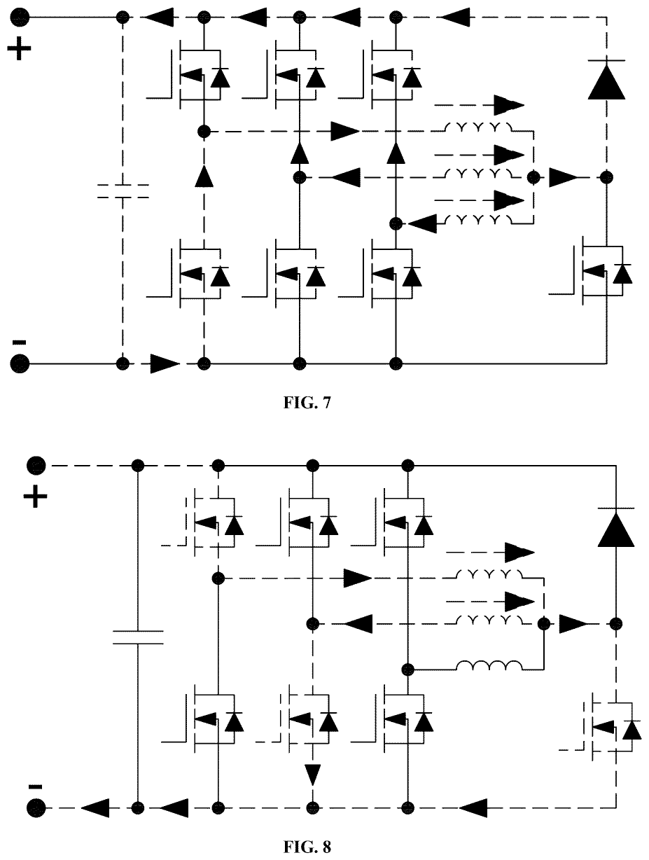

In the freewheeling path, starting from the negative power terminal, a freewheeling current sequentially flows through a parasitic diode of a lower power switch of the inverter bridge arm A and the phase-A winding to the neutral point for the three-phase windings, then flows through the FWD of the additional bridge arm to the positive power terminal in a first path, sequentially flows through the phase-B winding and a parasitic diode of an upper power switch of the inverter bridge arm B to the positive power terminal in a second path, and sequentially flows through the phase-C winding and a parasitic diode of an upper power switch of the inverter bridge arm C to the positive power terminal in a third path. See FIG. 7 for specific details.

### II: A Two-Phase Conduction Mode:

The power switch of the additional bridge arm is conducted to two-phase windings, such that the SRM enters the two-phase conduction mode. In this mode, the three-phase inverter is controlled with the universal method, such that the upper power switches of three inverter bridge arms are conducted alternately, and when an upper power switch of one inverter bridge arm is conducted, a lower power switch of another inverter bridge arm is conducted.

Taking that the upper power switch of the inverter bridge arm A and the lower power switch of the inverter bridge arm B are conducted at the same time as an example, an excitation path, a freewheeling path, and two demagnetization paths are respectively as follows:

In the excitation path, starting from the positive power terminal, an exciting current sequentially flows through the upper power switch of the inverter bridge arm A and the phase-A winding to the neutral point for the three-phase windings, then flows through the power switch of the additional bridge arm to the negative power terminal in a first path, and sequentially flows through the phase-B winding and the lower power switch of the inverter bridge arm B to the negative power terminal in a second path. See FIG. 8 for specific details.

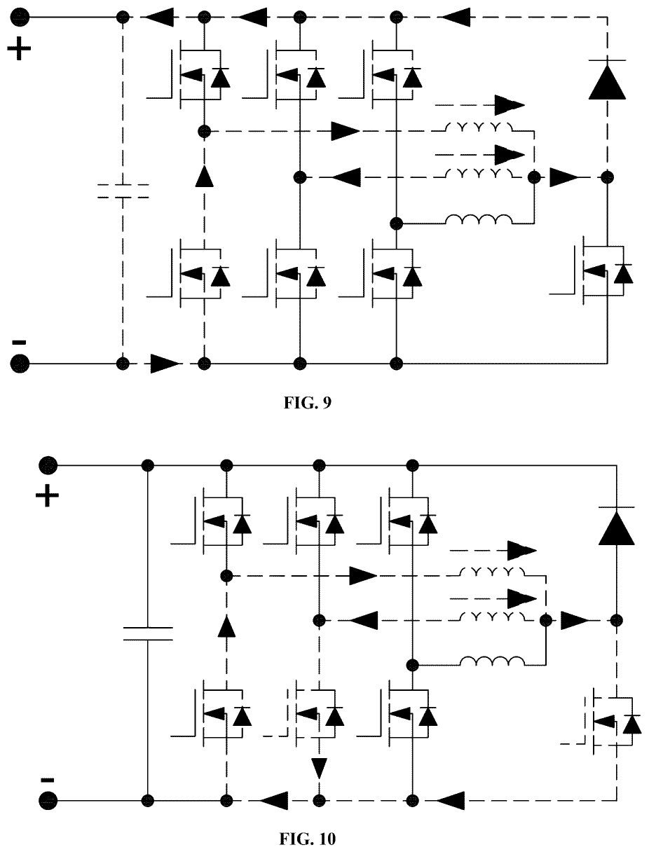

In the freewheeling path, starting from the negative power terminal, a freewheeling current sequentially flows through the parasitic diode of the lower power switch of the inverter bridge arm A and the phase-A winding to the neutral point for the three-phase windings, then flows through the FWD of the additional bridge arm to the positive power terminal in a first path, and sequentially flows through the phase-B winding and the parasitic diode of the upper power switch of the inverter bridge arm B to the positive power terminal in a second path. See FIG. 9 for specific details.

In a first demagnetization path, starting from the negative power terminal, a demagnetizing current sequentially flows through the parasitic diode of the lower power switch of the inverter bridge arm A and the phase-A winding to the neutral point for the three-phase windings, then flows through the power switch of the additional bridge arm to the negative power terminal in a first path, and sequentially flows through the phase-B winding and the lower power switch of the inverter bridge arm B to the negative power terminal in a second path. See FIG. 10 for specific details.

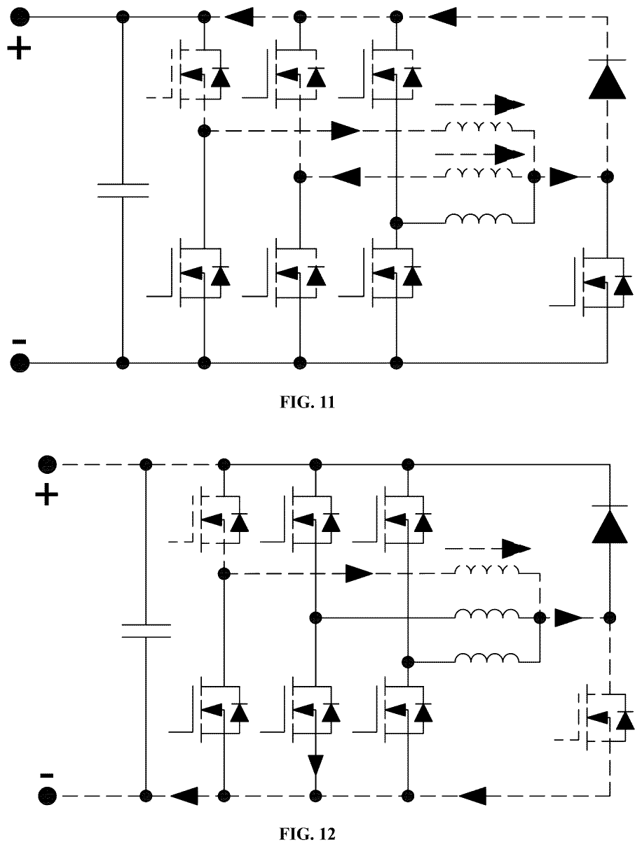

In a second demagnetization path, starting from the positive power terminal, a demagnetizing current sequentially flows through the upper power switch of the inverter bridge arm A and the phase-A winding to the neutral point for the three-phase windings, then flows through the FWD of the additional bridge arm to the positive power terminal in a first path, and sequentially flows through the phase-B winding and the parasitic diode of the upper power switch of the inverter bridge arm B to the positive power terminal in a second path. See FIG. 11 for specific details.

### III: A Single-Phase Conduction Mode:

The power switch of the additional bridge arm is conducted to a single-phase winding, such that the SRM enters the single-phase conduction mode. In this mode, the three-phase inverter is controlled with the universal method, such that the upper power switches of the three inverter bridge arms are conducted alternately.

Taking that the upper power switch of the inverter bridge arm A is conducted as an example, an excitation path and a freewheeling path are respectively as follows:

In the excitation path, starting from the positive power terminal, an exciting current sequentially flows through the upper power switch of the inverter bridge arm A and the phase-A winding to the neutral point for the three-phase windings, and then flows through the power switch of the additional bridge arm to the negative power terminal. See FIG. 12 for specific details.

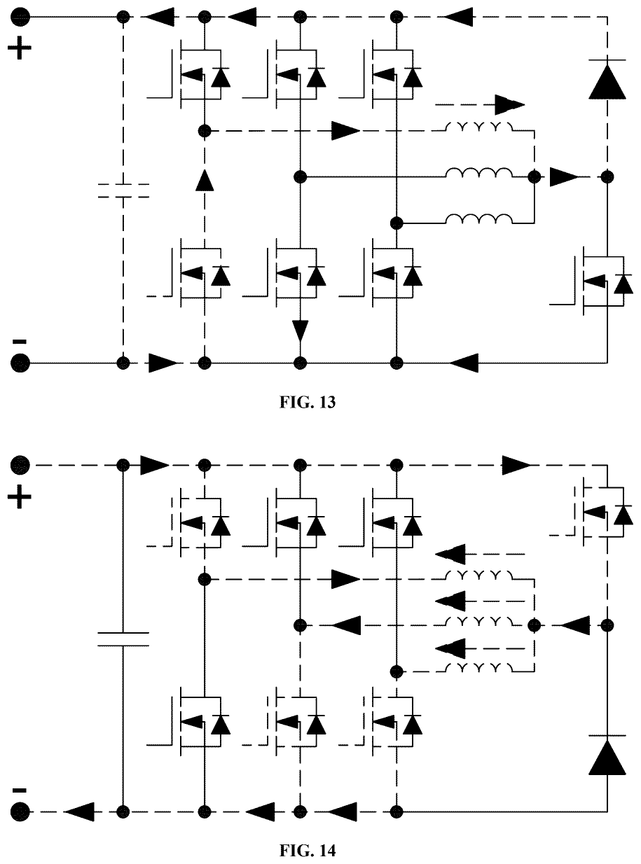

In the freewheeling path, starting from the negative power terminal, a freewheeling current sequentially flows through the parasitic diode of the lower power switch of the inverter bridge arm A and the phase-A winding to the neutral point for the three-phase windings, and then flows through the FWD of the additional bridge arm to the positive power terminal. See FIG. 13 for specific details.

The universal method includes, but is not limited to, a trapezoidal current driving method, a sinusoidal current control method, a field-oriented control method, a space vector control method, or a field weakening control method.

In another exemplary embodiment, the topological circuit for driving an SRM includes an SRM, an additional bridge arm, and N inverter bridge arms, N being a positive integer, and N≥2.

The SRM has N phases of windings connected in a star configuration. The additional bridge arm includes an FWD and a power switch that are connected in series, or two power switches that are connected in series. A positive input terminal of the additional bridge arm is connected to a positive power terminal. A negative input terminal of the additional bridge arm is connected to a negative power terminal. A midpoint of the additional bridge arm is connected to a neutral point for the N phases of windings. Positive input terminals of the N inverter bridge arms are connected to the positive power terminal. Negative input terminals of the N inverter bridge arms are connected to the negative power terminal. Midpoints of the N inverter bridge arms are connected to lead-out terminals of the N phases of windings in one-to-one correspondence. The N inverter bridge arms jointly constitute an N-phase inverter.

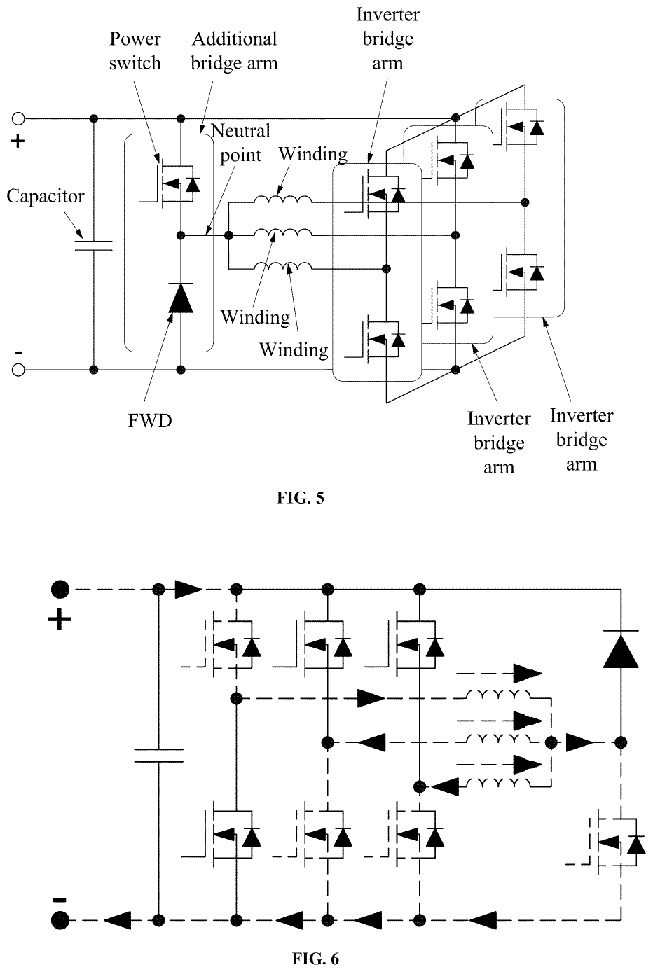

In the embodiment, a drain of the power switch of the additional bridge arm serves as the positive input terminal of the additional bridge arm. A source of the power switch of the additional bridge arm is connected to a cathode of the FWD of the additional bridge arm. An anode of the FWD of the additional bridge arm serves as the negative input terminal of the additional bridge arm. See FIG. 5 for specific details.

If N=3, a control strategy based on the topological circuit includes:

### I: A Three-Phase Conduction Mode:

The power switch of the additional bridge arm is conducted to three-phase windings, such that the SRM enters the three-phase conduction mode. In this mode, a three-phase inverter is controlled with a universal method, such that upper power switches of three inverter bridge arms are conducted alternately, and when an upper power switch of one inverter bridge arm is conducted, lower power switches of the other two inverter bridge arms are conducted, or lower power switches of the three inverter bridge arms are conducted alternately, and when a lower power switch of one inverter bridge arm is conducted, upper power switches of the other two inverter bridge arms are conducted.

Taking that an upper power switch of an inverter bridge arm A, a lower power switch of an inverter bridge arm B, and a lower power switch of an inverter bridge arm C are conducted at the same time as an example, an excitation path and a freewheeling path are respectively as follows:

In the excitation path, starting from the positive power terminal, an exciting current sequentially flows through the upper power switch of the inverter bridge arm A and a phase-A winding to a neutral point for the three-phase windings in a first path, and flows through the power switch of the additional bridge arm to the neutral point for the three-phase windings in a second path. Then, the exciting current sequentially flows through a phase-B winding and the lower power switch of the inverter bridge arm B to the negative power terminal in a first path, and sequentially flows through a phase-C winding and the lower power switch of the inverter bridge arm C to the negative power terminal in a second path. See FIG. 14 for specific details.

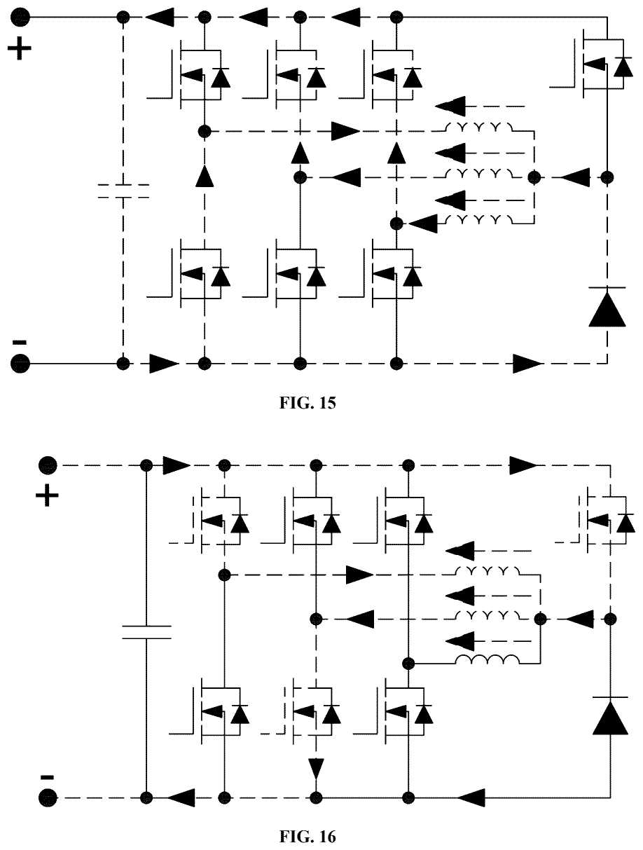

In the freewheeling path, starting from the negative power terminal, a freewheeling current sequentially flows through a parasitic diode of a lower power switch of the inverter bridge arm A and the phase-A winding to the neutral point for the three-phase windings in a first path, and flows through the FWD of the additional bridge arm to the neutral point for the three-phase windings in a second path. Then, the freewheeling current sequentially flows through the phase-B winding and a parasitic diode of an upper power switch of the inverter bridge arm B to the positive power terminal in a first path, and sequentially flows through the phase-C winding and a parasitic diode of an upper power switch of the inverter bridge arm C to the positive power terminal in a second path. See FIG. 15 for specific details.

### II: A Two-Phase Conduction Mode:

The power switch of the additional bridge arm is conducted to two-phase windings, such that the SRM enters the two-phase conduction mode. In this mode, the three-phase inverter is controlled with the universal method, such that the upper power switches of the three inverter bridge arms are conducted alternately, and when an upper power switch of one inverter bridge arm is conducted, a lower power switch of another inverter bridge arm is conducted.

Taking that the upper power switch of the inverter bridge arm A and the lower power switch of the inverter bridge arm B are conducted at the same time as an example, an excitation path, a freewheeling path, and two demagnetization paths are respectively as follows:

In the excitation path, starting from the positive power terminal, an exciting current sequentially flows through the upper power switch of the inverter bridge arm A and the phase-A winding to the neutral point for the three-phase windings in a first path, flows through the power switch of the additional bridge arm to the neutral point for the three-phase windings in a second path, and then sequentially flows through the phase-B winding and the lower power switch of the inverter bridge arm B to the negative power terminal. See FIG. 16 for specific details.

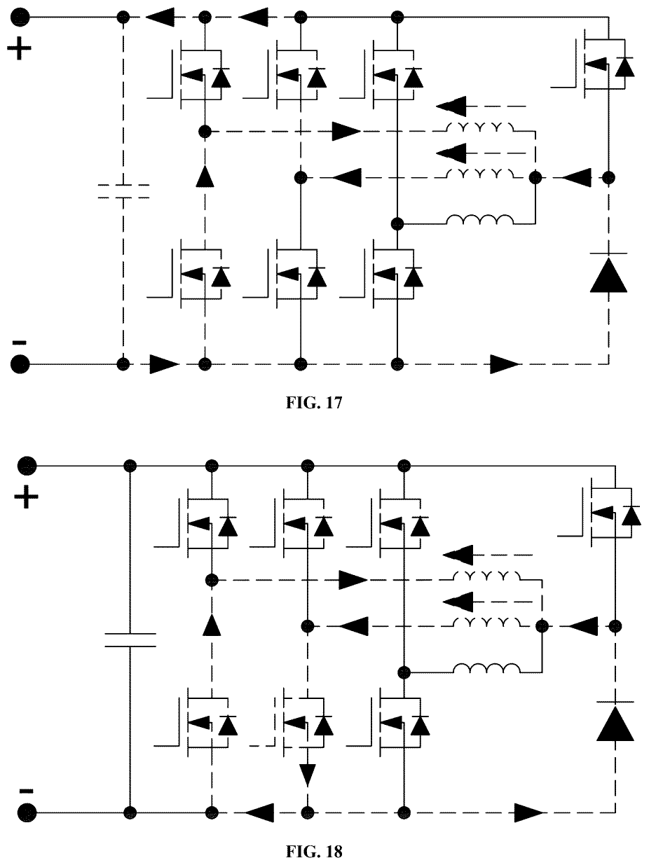

In the freewheeling path, starting from the negative power terminal, a freewheeling current sequentially flows through the parasitic diode of the lower power switch of the inverter bridge arm A and the phase-A winding to the neutral point for the three-phase windings in a first path, flows through the FWD of the additional bridge arm to the neutral point for the three-phase windings in a second path, and then sequentially flows through the phase-B winding and the parasitic diode of the upper power switch of the inverter bridge arm B to the positive power terminal. See FIG. 17 for specific details.

In a first demagnetization path, starting from the negative power terminal, a demagnetizing current sequentially flows through the parasitic diode of the lower power switch of the inverter bridge arm A and the phase-A winding to the neutral point for the three-phase windings in a first path, flows through the FWD of the additional bridge arm to the neutral point for the three-phase windings in a second path, and then sequentially flows through the phase-B winding and the lower power switch of the inverter bridge arm B to the negative power terminal. See FIG. 18 for specific details.

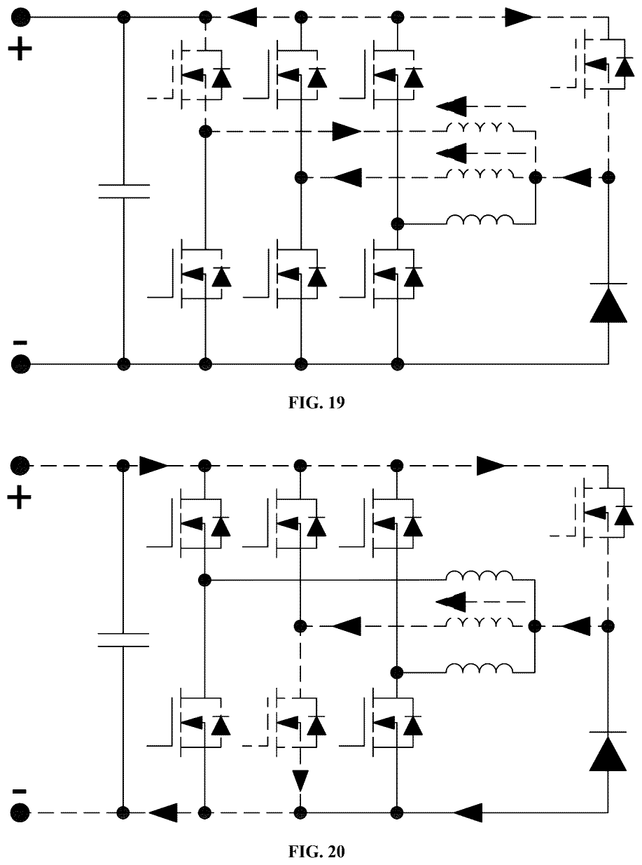

In a second demagnetization path, starting from the positive power terminal, a demagnetizing current sequentially flows through the upper power switch of the inverter bridge arm A and the phase-A winding to the neutral point for the three-phase windings in a first path, flows through the power switch of the additional bridge arm to the neutral point for the three-phase windings in a second path, and then sequentially flows through the phase-B winding and the parasitic diode of the upper power switch of the inverter bridge arm B to the positive power terminal. See FIG. 19 for specific details.

### III: A Single-Phase Conduction Mode:

The power switch of the additional bridge arm is conducted to a single-phase winding, such that the SRM enters the single-phase conduction mode. In this mode, the three-phase inverter is controlled with the universal method, such that the lower power switches of the three inverter bridge arms are conducted alternately.

Taking that the lower power switch of the inverter bridge arm B is conducted as an example, an excitation path and a freewheeling path are respectively as follows:

In the excitation path, starting from the positive power terminal, an exciting current flows through the power switch of the additional bridge arm to the neutral point for the three-phase windings, and then flows through the phase-B winding and the lower power switch of the inverter bridge arm B to the negative power terminal. See FIG. 20 for specific details.

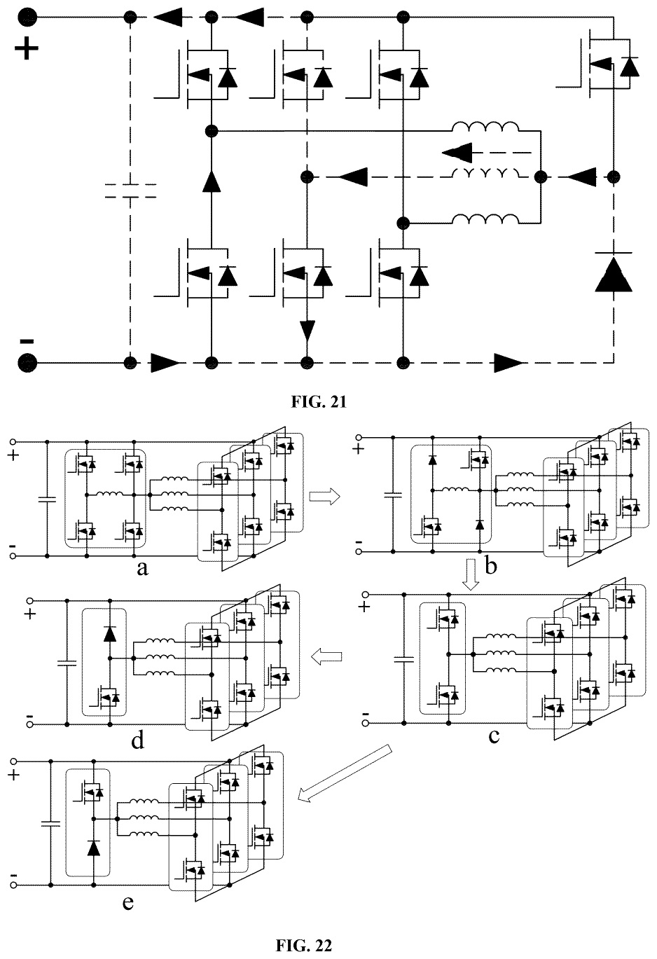

In the freewheeling path, starting from the negative power terminal, a freewheeling current flows through the FWD of the additional bridge arm to the neutral point for the three-phase windings, and then flows through the phase-B winding and the parasitic diode of the upper power switch of the inverter bridge arm B to the positive power terminal. See FIG. 21 for specific details.

The universal method includes, but is not limited to, a trapezoidal current driving method, a sinusoidal current control method, a field-oriented control method, a space vector control method, or a field weakening control method.

FIG. 22 shows a technical evolution path of the topological circuit in the embodiment. Panel a in FIG. 22 illustrates an initial concept of the present disclosure. After three-phase windings of the SRM are connected in a star configuration, lead-out terminals of the three-phase windings are connected to a three-phase inverter. Meanwhile, a neutral point for the three-phase windings is connected to an inertial device (an inductor in the figure). Full-bridge circuits are respectively connected to two terminals of the inertial device, so as to control a current flowing through the inertial device, thereby controlling a current at the neutral point. This concept is intended to realize a same direction for the current in each winding by controlling the current at the neutral point, thereby realizing unipolar excitation for each winding.

Panel b in FIG. 22 illustrates an improved concept based on panel a in FIG. 22. According to the concept of panel a in FIG. 22, the direction for the current flowing through the inertial device is the same all the time. Hence, the full-bridge circuits shown by panel a in FIG. 22 can be improved to asymmetrical half-bridge circuits. Such improvement can reduce the number of power switches in the circuit, and still can control the direction for the current at the neutral point.

Panel c in FIG. 22 illustrates an improved concept based on panel b in FIG. 22. According to the improved concept, the inertial device shown by panel b in FIG. 22 is removed. Meanwhile, the asymmetrical half-bridge circuits are optimized as an additional bridge arm composed of two power switches, so as to directly control the current at the neutral point, thereby ensuring the unipolar excitation on each winding, i.e., ensuring that the direction for the current in each winding is the same all the time.

Panel d in FIG. 22 and panel e in FIG. 22 each illustrate a final evolution concept based on panel c in FIG. 22, i.e., the topological circuit in the present disclosure. Due to a fixed direction for the current at the neutral point, one power switch of the additional bridge arm shown by panel c in FIG. 22 is closed all the time, and only its parasitic diode plays a freewheeling effect. Hence, according to different directions for currents of the windings, one power switch of the additional bridge arm shown by panel c in FIG. 22 may be replaced by an FWD, further reducing the number of the power switches and the complexity of the circuit topology and control.

The current at the neutral point shown by panel d in FIG. 22 is from right to left, while the current at the neutral point shown by panel e in FIG. 22 is from left to right. For panel d in FIG. 22, the currents of the windings come from an upper half arm of the inverter bridge arm, and the current at the neutral point is controlled passively by the additional bridge arm. For panel e in FIG. 22, the currents of the windings come from the additional bridge arm. In this case, the current at the neutral point is controlled actively by the power switch of the additional bridge arm. Panel d in FIG. 22 and panel e in FIG. 22 are the same in basic control solution and operating principle, but differ in the process for controlling the current at the neutral point and the excitation source for the currents of the windings.

Each embodiment in the description is described in a progressive mode, each embodiment focuses on differences from other embodiments, and references can be made to each other for the same and similar parts between embodiments.

Several examples are used herein for illustration of the principles and implementations of the present disclosure. The description of the foregoing examples is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

What is claimed is:

1. A topological circuit for driving a switched reluctance motor (SRM), comprising: an SRM, a capacitor (C), M power switch bridge arms, and M K-phase inverters, M and K each being a positive integer, and K≥2, wherein
the SRM has an N-phase winding structure, N=M×K; every K phases of windings form an independent set of symmetrical K-phase windings; and the symmetrical K-phase windings in each set of symmetrical K-phase windings are connected in a star configuration;
two terminals of the capacitor (C) are respectively connected to a positive power terminal and a negative power terminal;
positive input terminals of the M power switch bridge arms are connected to the positive power terminal; negative input terminals of the M power switch bridge arms are connected to the negative power terminal; and midpoints of the M power switch bridge arms are connected to neutral points of M sets of symmetrical K-phase windings in one-to-one correspondence; and
positive input terminals of the M K-phase inverters are connected to the positive power terminal; negative input terminals of the M K-phase inverters are connected to the negative power terminal; and K output terminals of the M K-phase inverters are connected to lead-out terminals of the M sets of symmetrical K-phase windings in one-to-one correspondence.

2. A control strategy for driving a switched reluctance motor (SRM), wherein the control strategy for driving an SRM is realized based on the topological circuit for driving an SRM according to claim 1, and the control strategy for driving an SRM comprises following control modes:
I: a motor mode:
controlling the M K-phase inverters with a universal method, such that a direct-current (DC) power supply is converted into M K-phase alternating-current (AC) power supplies by the M K-phase inverters, and the M sets of symmetrical K-phase windings are powered on; and
controlling the M power switch bridge arms, such that actual values of currents at the neutral points of the M sets of symmetrical K-phase windings each are maintained at a preset reference value, and an actual value of a current of each phase of winding is greater than or equal to 0 A, or the actual value of the current of each phase of winding is less than or equal to 0 A, thereby keeping the current of each phase of winding at a same direction, and enabling the SRM to enter the motor mode; and
II: a generator mode:
controlling the M power switch bridge arms, such that a power switch in each of the M power switch bridge arms is conducted; and controlling the M K-phase inverters, such that a power switch in each of the M K-phase inverters is conducted, wherein starting from the positive power terminal, an exciting current sequentially flows through the power switch conducted in the power switch bridge arm, one phase of winding in the symmetrical K-phase windings and the power switch conducted in the K-phase inverter to the negative power terminal, or sequentially flows through the power switch conducted in the K-phase inverter, the winding in the symmetrical K-phase windings and the power switch conducted in the power switch bridge arm to the negative power terminal, thereby enabling the SRM to enter an excitation state; and
upon completion of excitation, enabling the SRM to rotate continuously, and turning off the M power switch bridge arms, such that the SRM enters a generating mode.

3. The control strategy for driving an SRM according to claim 2, wherein the universal method comprises a trapezoidal current driving method, a sinusoidal current control method, a field-oriented control method, a space vector control method, or a field weakening control method.

4. The control strategy for driving an SRM according to claim 2, wherein there are three methods for setting the reference value for the current at the neutral point:
a first method is to directly set the reference value;
a second method is to sum peaks of currents of K bridge arms of the K-phase inverter, and set a summed result as the reference value for the current at the neutral point; wherein, taking a three-phase inverter as an example, a set formula is as follows:
$${i}_{tail}^{*} = \vert {i}_{l e g 1} {\vert}_{p e a k} + \vert {i}_{l e g 2} {\vert}_{p e a k} + \vert {i}_{l e g 3} {\vert}_{p e a k}$$
wherein
$${i}_{tail}^{*}$$
represents a reference value for a current at a neutral point, |i_{leg1}|ₚₑₐₖ represents a peak of a current of a first bridge arm of the three-phase inverter, |i_{leg2}|ₚₑₐₖ represents a peak of a current of a second bridge arm of the three-phase inverter, and |i_{leg3}|ₚₑₐₖ represents a peak of a current of a third bridge arm of the three-phase inverter; and
a third method is to sum absolute values of reference values of amplitudes of the currents of the K bridge arms of the K-phase inverter, multiply a summed result by 1.5, and set a resulting product as the reference value for the current at the neutral point; wherein, taking the three-phase inverter as an example, a set formula is as follows:
$${i}_{tail}^{*} = 1 \text{.5} ( \vert {i}_{a}^{*} \vert + \vert {i}_{b}^{*} \vert + \vert {i}_{c}^{*} \vert )$$
wherein
$${i}_{tail}^{*}$$
represents the reference value for the current at the neutral point,
$${i}_{a}^{*}$$
represents a reference value of an amplitude of the current of the first bridge arm of the three-phase inverter,
$${i}_{b}^{*}$$
represents a reference value of an amplitude of the current of the second bridge arm of the three-phase inverter, and
$${i}_{c}^{*}$$
represents a reference value of an amplitude of the current of the third bridge arm of the three-phase inverter.

5. A topological circuit for driving a switched reluctance motor (SRM), comprising: an SRM, an additional bridge arm, and N inverter bridge arms, N being a positive integer, and N≥2, wherein
the SRM comprises N phases of windings connected in a star configuration;
the additional bridge arm comprises a freewheeling diode (FWD) and a power switch that are connected in series;
a positive input terminal of the additional bridge arm is connected to a positive power terminal; a negative input terminal of the additional bridge arm is connected to a negative power terminal; and a midpoint of the additional bridge arm is connected to a neutral point for the N phases of windings; and
positive input terminals of the N inverter bridge arms are connected to the positive power terminal; negative input terminals of the N inverter bridge arms are connected to the negative power terminal; midpoints of the N inverter bridge arms are connected to lead-out terminals of the N phases of windings in one-to-one correspondence; and the N inverter bridge arms jointly constitute an N-phase inverter.

6. The topological circuit for driving an SRM according to claim 5, wherein a cathode of the FWD of the additional bridge arm serves as the positive input terminal of the additional bridge arm; an anode of the FWD of the additional bridge arm is connected to a drain of the power switch of the additional bridge arm; and a source of the power switch of the additional bridge arm serves as the negative input terminal of the additional bridge arm.

7. The topological circuit for driving an SRM according to claim 6, wherein if N=3, a control strategy based on the topological circuit comprises:
I: a three-phase conduction mode:
conducting the power switch of the additional bridge arm to three-phase windings, such that the SRM enters the three-phase conduction mode, wherein in the three-phase conduction mode, a three-phase inverter is controlled with a universal method, such that upper power switches of three inverter bridge arms are conducted alternately, and when an upper power switch of one inverter bridge arm is conducted, lower power switches of the other two inverter bridge arms are conducted, or lower power switches of the three inverter bridge arms are conducted alternately, and when a lower power switch of one inverter bridge arm is conducted, upper power switches of the other two inverter bridge arms are conducted; and
taking that an upper power switch of an inverter bridge arm A, a lower power switch of an inverter bridge arm B, and a lower power switch of an inverter bridge arm C are conducted at the same time as an example, an excitation path and a freewheeling path are respectively as follows:
in the excitation path, starting from the positive power terminal, an exciting current sequentially flows through the upper power switch of the inverter bridge arm A and a phase-A winding to a neutral point for the three-phase windings, then flows through the power switch of the additional bridge arm to the negative power terminal in a first path, sequentially flows through a phase-B winding and the lower power switch of the inverter bridge arm B to the negative power terminal in a second path, and sequentially flows through a phase-C winding and the lower power switch of the inverter bridge arm C to the negative power terminal; and
in the freewheeling path, starting from the negative power terminal, a freewheeling current sequentially flows through a parasitic diode of a lower power switch of the inverter bridge arm A and the phase-A winding to the neutral point for the three-phase windings, then flows through the FWD of the additional bridge arm to the positive power terminal in a first path, sequentially flows through the phase-B winding and a parasitic diode of an upper power switch of the inverter bridge arm B to the positive power terminal in a second path, and sequentially flows through the phase-C winding and a parasitic diode of an upper power switch of the inverter bridge arm C to the positive power terminal in a third path;
II: a two-phase conduction mode:
conducting the power switch of the additional bridge arm to two-phase windings, such that the SRM enters the two-phase conduction mode, wherein in the two-phase conduction mode, the three-phase inverter is controlled with the universal method, such that the upper power switches of three inverter bridge arms are conducted alternately, and when an upper power switch of one inverter bridge arm is conducted, a lower power switch of another inverter bridge arm is conducted; and
taking that the upper power switch of the inverter bridge arm A and the lower power switch of the inverter bridge arm B are conducted at the same time as an example, an excitation path, a freewheeling path, and two demagnetization paths are respectively as follows:
in the excitation path, starting from the positive power terminal, an exciting current sequentially flows through the upper power switch of the inverter bridge arm A and the phase-A winding to the neutral point for the three-phase windings, then flows through the power switch of the additional bridge arm to the negative power terminal in a first path, and sequentially flows through the phase-B winding and the lower power switch of the inverter bridge arm B to the negative power terminal in a second path;
in the freewheeling path, starting from the negative power terminal, a freewheeling current sequentially flows through the parasitic diode of the lower power switch of the inverter bridge arm A and the phase-A winding to the neutral point for the three-phase windings, then flows through the FWD of the additional bridge arm to the positive power terminal in a first path, and sequentially flows through the phase-B winding and the parasitic diode of the upper power switch of the inverter bridge arm B to the positive power terminal in a second path;
in a first demagnetization path, starting from the negative power terminal, a demagnetizing current sequentially flows through the parasitic diode of the lower power switch of the inverter bridge arm A and the phase-A winding to the neutral point for the three-phase windings, then flows through the power switch of the additional bridge arm to the negative power terminal in a first path, and sequentially flows through the phase-B winding and the lower power switch of the inverter bridge arm B to the negative power terminal in a second path; and
in a second demagnetization path, starting from the positive power terminal, a demagnetizing current sequentially flows through the upper power switch of the inverter bridge arm A and the phase-A winding to the neutral point for the three-phase windings, then flows through the FWD of the additional bridge arm to the positive power terminal in a first path, and sequentially flows through the phase-B winding and the parasitic diode of the upper power switch of the inverter bridge arm B to the positive power terminal in a second path; and
III: a single-phase conduction mode:
conducting the power switch of the additional bridge arm to a single-phase winding, such that the SRM enters the single-phase conduction mode, wherein in the single-phase conduction mode, the three-phase inverter is controlled with the universal method, such that the upper power switches of three inverter bridge arms are conducted alternately; and
taking that the upper power switch of the inverter bridge arm A is conducted as an example, an excitation path and a freewheeling path are respectively as follows:
in the excitation path, starting from the positive power terminal, an exciting current sequentially flows through the upper power switch of the inverter bridge arm A and the phase-A winding to the neutral point for the three-phase windings, and then flows through the power switch of the additional bridge arm to the negative power terminal; and
in the freewheeling path, starting from the negative power terminal, a freewheeling current sequentially flows through the parasitic diode of the lower power switch of the inverter bridge arm A and the phase-A winding to the neutral point for the three-phase windings, and then flows through the FWD of the additional bridge arm to the positive power terminal.

8. The topological circuit for driving an SRM according to claim 5, wherein a drain of the power switch of the additional bridge arm serves as the positive input terminal of the additional bridge arm; a source of the power switch of the additional bridge arm is connected to a cathode of the FWD of the additional bridge arm; and an anode of the FWD of the additional bridge arm serves as the negative input terminal of the additional bridge arm.

9. The topological circuit for driving an SRM according to claim 8, wherein if N=3, a control strategy based on the topological circuit comprises:
I: a three-phase conduction mode:
conducting the power switch of the additional bridge arm to three-phase windings, such that the SRM enters the three-phase conduction mode, wherein in the three-phase conduction mode, a three-phase inverter is controlled with a universal method, such that upper power switches of three inverter bridge arms are conducted alternately, and when an upper power switch of one inverter bridge arm is conducted, lower power switches of the other two inverter bridge arms are conducted, or lower power switches of the three inverter bridge arms are conducted alternately, and when a lower power switch of one inverter bridge arm is conducted, upper power switches of the other two inverter bridge arms are conducted; and
taking that an upper power switch of an inverter bridge arm A, a lower power switch of an inverter bridge arm B, and a lower power switch of an inverter bridge arm C are conducted at the same time as an example, an excitation path and a freewheeling path are respectively as follows:
in the excitation path, starting from the positive power terminal, an exciting current sequentially flows through the upper power switch of the inverter bridge arm A and a phase-A winding to a neutral point for the three-phase windings in a first path, and flows through the power switch of the additional bridge arm to the neutral point for the three-phase windings in a second path; and then, the exciting current sequentially flows through a phase-B winding and the lower power switch of the inverter bridge arm B to the negative power terminal in a first path, and sequentially flows through a phase-C winding and the lower power switch of the inverter bridge arm C to the negative power terminal in a second path; and
in the freewheeling path, starting from the negative power terminal, a freewheeling current sequentially flows through a parasitic diode of a lower power switch of the inverter bridge arm A and the phase-A winding to the neutral point for the three-phase windings in a first path, and flows through the FWD of the additional bridge arm to the neutral point for the three-phase windings in a second path; and then, the freewheeling current sequentially flows through the phase-B winding and a parasitic diode of an upper power switch of the inverter bridge arm B to the positive power terminal in a first path, and sequentially flows through the phase-C winding and a parasitic diode of an upper power switch of the inverter bridge arm C to the positive power terminal in a second path;
II: a two-phase conduction mode:
conducting the power switch of the additional bridge arm to two-phase windings, such that the SRM enters the two-phase conduction mode, wherein in the two-phase conduction mode, the three-phase inverter is controlled with the universal method, such that the upper power switches of the three inverter bridge arms are conducted alternately, and when an upper power switch of one inverter bridge arm is conducted, a lower power switch of another inverter bridge arm is conducted; and
taking that the upper power switch of the inverter bridge arm A and the lower power switch of the inverter bridge arm B are conducted at the same time as an example, an excitation path, a freewheeling path, and two demagnetization paths are respectively as follows:
in the excitation path, starting from the positive power terminal, an exciting current sequentially flows through the upper power switch of the inverter bridge arm A and the phase-A winding to the neutral point for the three-phase windings in a first path, flows through the power switch of the additional bridge arm to the neutral point for the three-phase windings in a second path, and then sequentially flows through the phase-B winding and the lower power switch of the inverter bridge arm B to the negative power terminal; and
in the freewheeling path, starting from the negative power terminal, a freewheeling current sequentially flows through the parasitic diode of the lower power switch of the inverter bridge arm A and the phase-A winding to the neutral point for the three-phase windings in a first path, flows through the FWD of the additional bridge arm to the neutral point for the three-phase windings in a second path, and then sequentially flows through the phase-B winding and the parasitic diode of the upper power switch of the inverter bridge arm B to the positive power terminal;
in a first demagnetization path, starting from the negative power terminal, a demagnetizing current sequentially flows through the parasitic diode of the lower power switch of the inverter bridge arm A and the phase-A winding to the neutral point for the three-phase windings in a first path, flows through the FWD of the additional bridge arm to the neutral point for the three-phase windings in a second path, and then sequentially flows through the phase-B winding and the lower power switch of the inverter bridge arm B to the negative power terminal; and
in a second demagnetization path, starting from the positive power terminal, a demagnetizing current sequentially flows through the upper power switch of the inverter bridge arm A and the phase-A winding to the neutral point for the three-phase windings in a first path, flows through the power switch of the additional bridge arm to the neutral point for the three-phase windings in a second path, and then sequentially flows through the phase-B winding and the parasitic diode of the upper power switch of the inverter bridge arm B to the positive power terminal; and
III: a single-phase conduction mode:
conducting the power switch of the additional bridge arm to a single-phase winding, such that the SRM enters the single-phase conduction mode, wherein in the single-phase conduction mode, the three-phase inverter is controlled with the universal method, such that the lower power switches of the three inverter bridge arms are conducted alternately; and
taking that the lower power switch of the inverter bridge arm B is conducted as an example, an excitation path and a freewheeling path are respectively as follows:
in the excitation path, starting from the positive power terminal, an exciting current flows through the power switch of the additional bridge arm to the neutral point for the three-phase windings, and then sequentially flows through the phase-B winding and the lower power switch of the inverter bridge arm B to the negative power terminal; and
in the freewheeling path, starting from the negative power terminal, a freewheeling current flows through the FWD of the additional bridge arm to the neutral point for the three-phase windings, and then sequentially flows through the phase-B winding and the parasitic diode of the upper power switch of the inverter bridge arm B to the positive power terminal.

10. The control strategy for driving an SRM according to claim 7, wherein the universal method comprises a trapezoidal current driving method, a sinusoidal current control method, a field-oriented control method, a space vector control method, or a field weakening control method.

11. The control strategy for driving an SRM according to claim 9, wherein the universal method comprises a trapezoidal current driving method, a sinusoidal current control method, a field-oriented control method, a space vector control method, or a field weakening control method.
